(19) United States
(12) Patent Application Publication
(10) Pub. No.: US 2019/0230213 A1
(43) Pub. Date: Jul. 25, 2019

(54) REDUCTION OF DRIVER DISTRACTION DUE TO A CELLULAR DEVICE

(71) Applicant: GM Global Technology Operations LLC, Detroit, MI (US)

(72) Inventors: Jeffrey L. Konchan, Romeo, MI (US); Joseph M. Polewarczyk, Rochester Hills, MI (US); Ron Y. Asmar, West Bloomfield, MI (US); Richard Lange, Troy, MI (US)

(21) Appl. No.: 15/874,982

(22) Filed: Jan. 19, 2018

(51) Int. Cl. H04M 1/725; H04W 4/02

(52) U.S. Cl. CPC H04M 1/72577; B60N 2/002; H04W 4/023

(57) ABSTRACT

A system and method to control a cellular device in a vehicle includes determining whether the cellular device is associated with a driver of the vehicle based on a location of the cellular device or an identity of the cellular device. The method also includes signaling the cellular device to inhibit functionality of the cellular device based on determining that the cellular device is associated with the driver of the vehicle. The inhibiting functionality includes disabling one or more functions of the cellular device.

### INTRODUCTION

The subject disclosure relates to the reduction of driver distraction due to cellular devices.

Cellular devices are increasingly capable. In addition to communication via voice or text, the devices facilitate access to the internet and various applications such as mapping applications that provide voice-guided directions. Some capabilities of cellular devices, such as mapping functionalities, for example, may be useful to a driver of a vehicle (e.g., automobile, truck, construction equipment). However, other capabilities, such as texting, for example, may prove to be an unsafe distraction for vehicle drivers. Accordingly, it is desirable to reduce driver distraction due to a cellular device.

### SUMMARY

In one exemplary embodiment, a method of controlling a cellular device in a vehicle includes determining whether the cellular device is associated with a driver of the vehicle based on a location of the cellular device or an identity of the cellular device. The method also includes signaling the cellular device to inhibit functionality of the cellular device based on determining that the cellular device is associated with the driver of the vehicle. The inhibiting functionality includes disabling one or more functions of the cellular device.

In addition to one or more of the features described herein, the method also includes using an ultra-wideband system to determine the location of the cellular device in the vehicle.

In addition to one or more of the features described herein, the determining whether the cellular device is associated with the driver based on the location of the cellular device includes determining whether the location of the cellular device is closer to a driver seat in the vehicle than to any other seat in the vehicle.

In addition to one or more of the features described herein, determining whether a passenger is present in a seat closest to the location of the cellular device based on the determining whether the cellular device is associated with the driver indicating that the cellular device is not associated with the driver based on the location of the cellular device.

In addition to one or more of the features described herein, the method also includes performing the inhibiting functionality of the cellular device based on the determining whether the passenger is present indicating that the passenger is not present in the seat closest to the location of the cellular device.

In addition to one or more of the features described herein, the method also includes determining the identity of the cellular device based on the cellular device pairing with an infotainment system of the vehicle.

In addition to one or more of the features described herein, the method also includes determining an identity of a key fob associated with the driver.

In addition to one or more of the features described herein, the determining whether the cellular device is associated with the driver based on the identity of the cellular device includes determining whether the identity of the cellular device matches the identity of the key fob associated with the driver.

In addition to one or more of the features described herein, the inhibiting functionality of the one or more functions includes disabling texting, internet searching, and gaming functionality.

In addition to one or more of the features described herein, the inhibiting functionality also includes maintaining mapping functionality and Bluetooth connectivity to an infotainment system of the vehicle.

In another exemplary embodiment, a system to control a cellular device in a vehicle includes a processor to determine whether the cellular device is associated with a driver of the vehicle based on a location of the cellular device or an identity of the cellular device. The system also includes a communication unit to signal the cellular device to inhibit functionality of the cellular device based on determining that the cellular device is associated with the driver of the vehicle. The inhibiting functionality includes disabling one or more functions of the cellular device.

In addition to one or more of the features described herein, the system also includes an ultra-wideband system configured to determine the location of the cellular device in the vehicle.

In addition to one or more of the features described herein, the processor determines whether the cellular device is associated with the driver based on the location of the cellular device by determining whether the location of the cellular device is closer to a driver seat in the vehicle than to any other seat in the vehicle.

In addition to one or more of the features described herein, the processor determines whether a passenger is present in a seat closest to the location of the cellular device when the processor determines that the cellular device is not associated with the driver based on the location of the cellular device.

In addition to one or more of the features described herein, the communication unit signals the cellular device to inhibit functionality based on the processor determining that the passenger is not present in the seat closest to the location of the cellular device.

In addition to one or more of the features described herein, the processor determines the identity of the cellular device based on the cellular device pairing with an infotainment system of the vehicle.

In addition to one or more of the features described herein, the processor determines an identity of a key fob associated with the driver.

In addition to one or more of the features described herein, the processor determines whether the cellular device is associated with the driver based on the identity of the cellular device by determining whether the identity of the cellular device matches the identity of the key fob associated with the driver.

In addition to one or more of the features described herein, the one or more functions includes texting, internet searching, and gaming functionality.

In addition to one or more of the features described herein, the processor inhibiting functionality also includes maintaining mapping functionality and Bluetooth connectivity to an infotainment system of the vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an exemplary vehicle in which cellular device functionality is inhibited according to one or more embodiments;

FIG. 2 is a process flow of a method of reducing driver distraction due to a cellular device according to an exemplary embodiment;

FIG. 3 is a process flow of a method of reducing driver distraction due to cellular devices according to another exemplary embodiment; and

FIG. 4 is a process flow of methods of locating passengers in the vehicle according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, some capabilities of cellular devices may be helpful to the driver of a vehicle, but other capabilities may distract the driver. Embodiments of the systems and methods detailed herein relate to the reduction of driver distraction due to a cellular device. Specifically, some or all functionality of a cellular device is inhibited according to two or more exemplary embodiments. According to one exemplary embodiment, the cellular devices may be localized within the vehicle passenger compartment. In this case, only cellular devices within a specified distance from the driver seat may have inhibited functionality. According to another exemplary embodiment, the driver may be identified and only a corresponding cellular device may be inhibited.

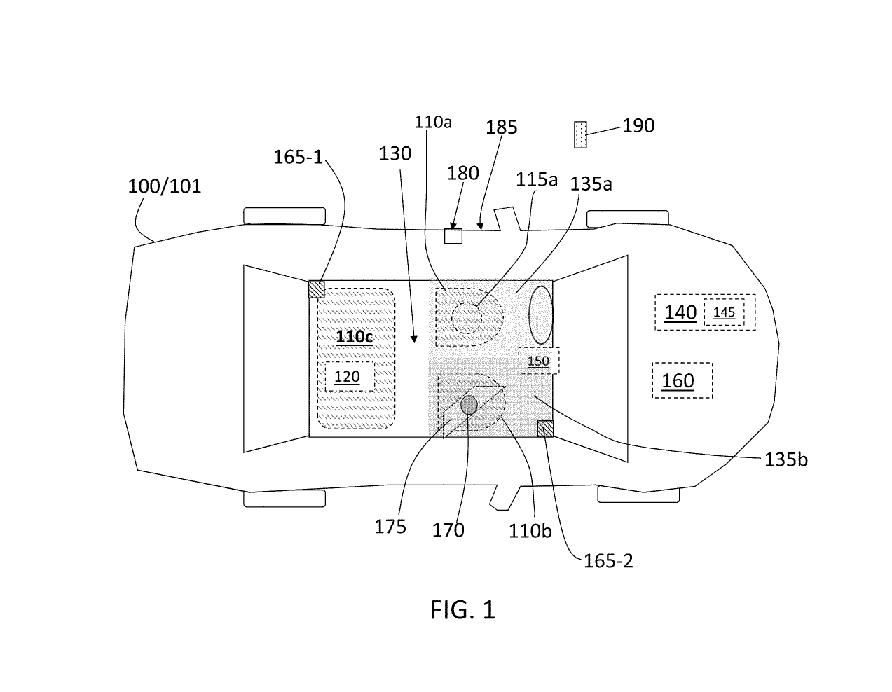

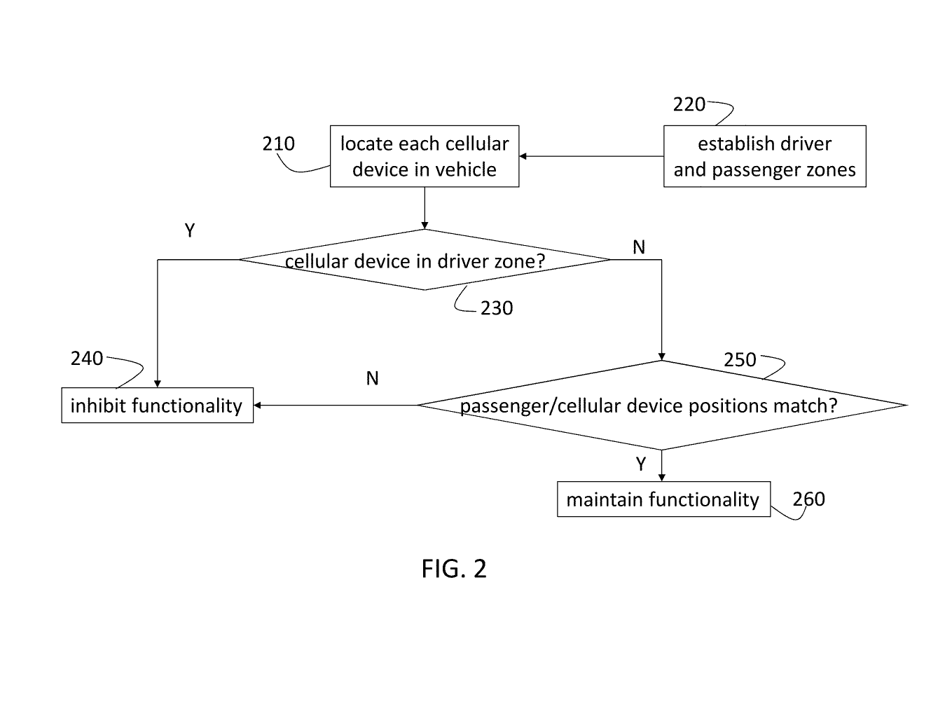

In accordance with an exemplary embodiment, FIG. 1 shows an exemplary vehicle 100 in which cellular device functionality is inhibited. The vehicle 100 shown in FIG. 1 is an automobile 101 with five seats 110. The driver seat 110a, front passenger seat 110b, and rear seat 110c, which may accommodate up to three passengers, are indicated. Each seat 110 and the area around it define a zone 135. The driver zone 135a and front passenger zone 135b are indicated in FIG. 1 and discussed further with reference to FIG. 2. Generally, a zone 135 is associated with the seat 110 closest to it. For example, all of the area within the driver zone 135a is closer to the driver seat 110a than any other seat 100. A cellular device 120 is indicated in the passenger compartment 130 of the automobile 101. The cellular device 120 is specifically indicated as being on the rear seat 110c in the exemplary depiction.

The vehicle 100 may include a number of systems (e.g., collision avoidance, adaptive cruise control, radar, cameras) that facilitate object detection and avoidance through augmented or automated operation, for example. A controller 140 is shown in FIG. 1. The controller 140 may be the electronic control unit (ECU) that controls many of the vehicle systems or may be in communication with the ECU. The controller 140 includes processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. As shown in FIG. 1, the controller 140 includes a communication unit 145 to communicate with the cellular device 120. This communication may occur through the infotainment system 150 according to an alternate embodiment. The communication may additionally or alternately occur through a central server that relays messages between the controller 140 and the cellular device 120. According to one or more embodiments discussed herein, the controller 140 determines which cellular devices 120 should have inhibited functionality and may additionally specify which functionality should be inhibited.

The controller 140 also receives information from seatbelt sensors 170, door sensors 180, and an occupant detection system, according to one or more embodiments. Only one seatbelt sensor 170 and door sensor 180 are indicated in FIG. 1 for explanatory purposes, but each seatbelt 175 of the vehicle 100 may include an associated seatbelt sensor 170 and each door 185 of the vehicle 100 may include an associated door sensor 180 that provides an indication of each door-opening and door-closing event. The occupant detection system may include one or more sensors that determine seat occupancy for purposes of determining which airbags should be deployed, for example. The sensors of the occupant detection system may include infrared and ultrasound sensors and sensors to determine the weight on each seat 110 or at least the front seats 110a, 110b. An exemplary weight sensor 115a associated with the driver seat 110a is shown. A key fob 190 may be used to unlock the vehicle 100 and also to operate the vehicle 100 according to a keyless, push-to-start embodiment.

FIG. 1 indicates one of the vehicle systems, the infotainment system 150. The infotainment system 150 may include radio access technologies (RATs) such as, for example, those that facilitate reception of radio signals, global positioning system (GPS) signals, and access to WiFi. The infotainment system 150 may include Bluetooth capability to redirect some signals to and from the cellular device 120, as well. For example, voice signals may be redirected from the cellular device 120 to allow hands-free access through the infotainment system 150.

FIG. 1 also indicates an ultra-wideband (UWB) system 160 that is available in the vehicle 100 according to some exemplary embodiments. The UWB system 160 uses short-range, high-bandwidth communication that facilitates precision locating (e.g., to within 5 to 10 centimeters). Two UWB units 165-1, 165-2 (generally referred to as 165) are shown in FIG. 1, but more than two UWB units 165 may be disposed at different locations within the vehicle 100. Each UWB unit 165 may represent an antenna to transmit and receive UWB signals. The UWB system 160 may process the transmitted and received signals. In alternate embodiments, each UWB unit 165 may perform some or all of the processing involved with generating signals for transmission and obtaining information from received signals.

Location determination using the UWB system 160 is described with reference to FIG. 1. Transmission by the each of the UWB units 165 of the UWB system 160 may be of pulses over a large bandwidth (e.g., greater than 500 megaHertz). The location of each UWB unit 165 within the vehicle 100 is fixed. Thus, the time-of-flight of pulses from each of the UWB units 165 to a cellular device 120 and back is obtained (e.g., each UWB unit 165 transmits to a given cellular device 120 in turn), and trigonometric functions are used along with the time-of-flight information to locate the cellular device 120 relative to the positions of the UWB units 165.

FIG. 2 is a process flow of a method of reducing driver distraction due to a cellular device 120 according to an exemplary embodiment. According to the present embodiment, the vehicle 100 includes an operational UWB system 160 that can communicate with the cellular devices 120 in the passenger compartment 130 and determine the position of each cellular device 120 with an accuracy on the order of 10 cm. At block 210, locating each cellular device 120 in the vehicle 100 refers to using the UWB units 165 of the UWB system 160 to determine the location of each cellular device 120 within the passenger compartment 130. This process may be initiated when the vehicle 100 is turned on or when the speed of the vehicle 100 exceeds a predefined value. The condition for performing the process may be determined by the controller 140. If no cellular devices 120 are located in the passenger compartment 130, then the process flow shown in FIG. 2 may be terminated.

At block 220, establishing driver and passenger zones 135 is a process that may be performed once at any time prior to the other processes shown in FIG. 2. Each time a seat 110 is moved, electronically or manually, one or more zones 135 may be affected. For example, if the driver seat 110a is moved back, the driver zone 135a has an increased area while the zone associated with the rear seat 110c behind the driver seat 110a has a decreased area. Thus, the processes shown in FIG. 2 may be repeated after any seat position change. With the positions of each of the seats 110 being fixed and known within the passenger compartment 130, the area between seats 110 may be divided and associated with a particular zone 135 corresponding with the closest seat 110. For example, the area between the driver seat 110a and front passenger seat 110b may be divided evenly. The driver seat 110a and the half of the area between the driver seat 110a and the front passenger seat 110b that is closest to the driver seat 110a define the driver zone 135a, as indicated by FIG. 1, for example. Similarly, the other seats that areas around those seats define different passenger zones 135 (e.g., front passenger zone 135b).

At block 230, a determination is made of whether any cellular device 120 is in the driver zone 135a. If so, inhibiting functionality is performed, at block 240, for the cellular device 120 determined to be in the driver zone 135a. This process may involve the controller 140 sending a signal to the cellular device 120. The specific functionality that is inhibited in the cellular device 120 may be predefined or indicated by the controller 140. For example, the screen of the cellular device 120 may be blocked for all calls except to 911 or other predefined emergency numbers. Texting, gaming, and internet search features may be turned off entirely. Calls through the infotainment system 150 via a Bluetooth connection may still be permitted. Voice-guided directions from the cellular device 120 may still be permitted. The exemplary functionality discussed herein is not exhaustive and is not intended to limit the features of a given cellular device 120 that may be inhibited or permitted.

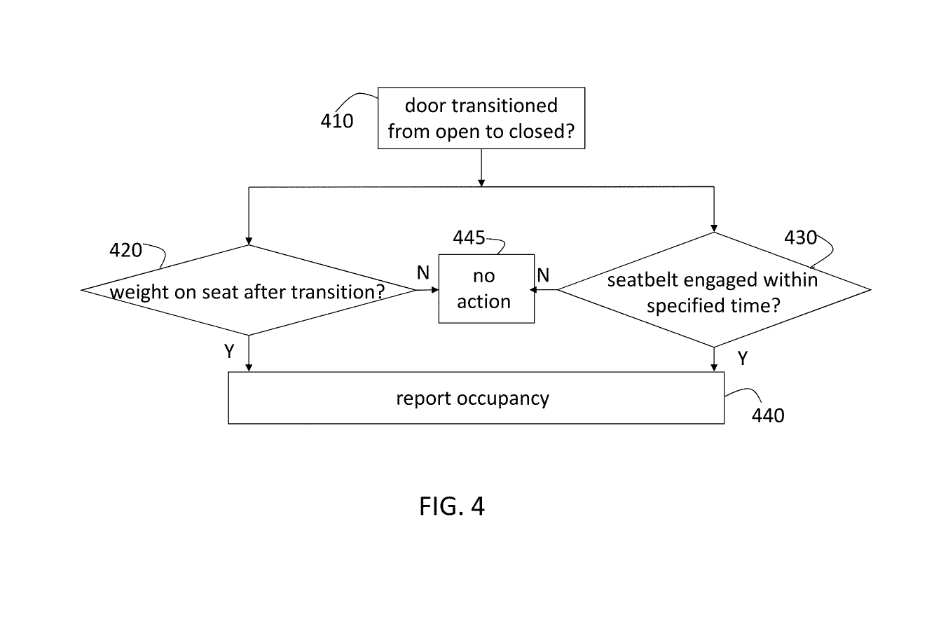

At block 230, if a determination is made that the cellular device 120 is not in the driver zone 135a, a check is then done of whether passenger and cellular device 120 positions match, at block 250. The process at block 250 relates to ensuring that the driver did not place a cellular device 120 on the front passenger seat 110b, for example, to avoid inhibition of functionality of the cellular device 120. The check at block 250 involves determining whether one or more passengers is in the vehicle 100 and, if so, where the one or more passengers are located. This process is further detailed with reference to FIG. 4. The check at block 250 then involves checking the passenger positions against the locations of the cellular device 120, as determined at block 210.

If the position of a cellular device 120 matches the position of a passenger, then maintaining functionality, at block 260, refers to the fact that no inhibiting signal is sent with respect to the cellular device 120. If the position of a cellular device 120 does not match the position of a passenger, then inhibiting functionality, at block 240, is performed for that cellular device 120. Thus, different cellular devices 120 in the passenger compartment 130 may be treated differently based on the correspondence of their location with passenger locations.

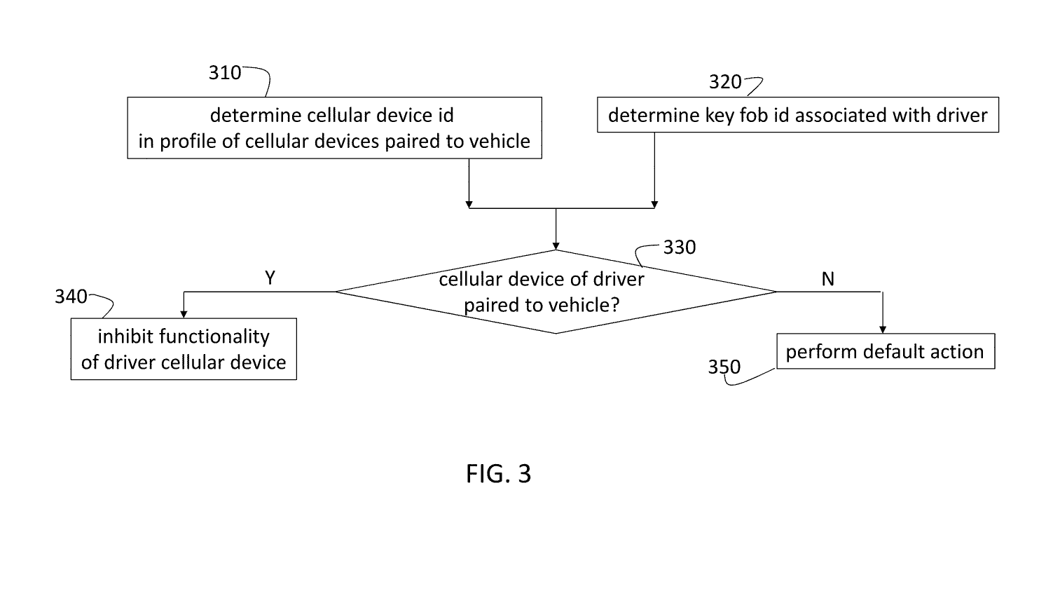

FIG. 3 is a process flow of a method of reducing driver distraction due to cellular devices 120 according to another exemplary embodiment. According to the present embodiment, the vehicle 100 may not include the UWB system 160 or the UWB system 160 may not be operational. Thus, the location of each cellular device 120 in the passenger compartment 130 cannot be determined using the UWB system 160. According to the present embodiment, identifiers associated with cellular devices 120 and key fobs 190 are used to determine which cellular device 120 is used by a driver.

At block 310, determining a cellular device 120 identity (id) in the profile of cellular devices 120 paired to the vehicle 100 refers to the fact that one or more cellular devices 120 may be paired to the vehicle 100 through the infotainment system 150. This known pairing facilitates conducting calls through the cellular device 120 using a microphone and speakers of the vehicle 100, for example. The pairing involves identifying the cellular device 120 so that the cellular device 120 is automatically connected again when it is subsequently present in the vehicle 100.

At block 320, the processes include determining key fob 190 identity (id) associated with the driver. The key fob 190 may facilitate adjustment of the driver seat 110 and other features that require associating an id with each key fob 190. In this case, the id associated with the key fob 190 of the driver may be determined. If more than one key fob 190 is in the vehicle 100, the id of the key fob 190 associated with the driver may be determined based on the door 185 through which the key fob 190 entered the vehicle 100 (e.g., the driver door 185).

At block 330, a check is done of whether the cellular device 120 of the driver is paired to the vehicle 100. That is, the id of the cellular devices 120 is compared with the id of the key fob 190 associated with the driver. If one of the cellular devices 120 has an id, determined at block 310, that is linked to the id, determined at block 320, for the key fob 190 of the driver, then it is determined, at block 330, that the cellular device 120 of the driver is connected to the vehicle 100. In this case, inhibiting the functionality of the cellular device 120 of the driver is performed at block 340 in the way described with reference to block 240.

If an id associated with any cellular device 120 in the vehicle 100 does not correspond with an id associated with a key fob 190 of the driver, then performing a default action, at block 350, is based on a setting in the controller 140. According to an exemplary embodiment, the default action may be to do nothing such that functionality of all the cellular devices 120 in the passenger compartment 120 is maintained. According to another exemplary embodiment, the default action may be inhibiting functionality of all cellular devices 120 in the passenger compartment 130 of the vehicle 100. According to the embodiments, if the driver's cellular device 120 cannot be determined, then none or all of the cellular devices 120 may be inhibited in their functionality.

The setting in the controller 140 that determines what the default action is may be changed by an authorized user. An authorized user may be one that enters a password via the infotainment system 150, for example. This authorized user may be determined in the same way for as for other vehicle functions. For example, a given cellular device 120 may be paired to the vehicle 100 in a teen driver mode. In this mode, only an authorized user (e.g., a parent) may be permitted to change or undo the pairing. Thus, the user of the cellular device 120 would not be permitted to undo the pairing and, thus, prevent the controller 140 from inhibiting functionality based on the identity of the key fob 190 matching the identity of the paired cellular device 120.

FIG. 4 is a process flow of methods of locating passengers in the vehicle 100 according to one or more embodiments. At block 410, the processes begin when one or more doors 185 transition from an open position to a closed position. The open or closed status of the door 185 is determined by the door sensor 180 and provided to the controller 140, to example. According to an exemplary embodiment, a check is done, at block 420, of whether a weight was detected on one of the passenger seats 110 after the transition of the door 185 to the closed position. This check may only apply to the front passenger seat 110b, because the front passenger seat 110b may include a weight detector for purposes of enabling or disabling the airbag on the front passenger side. As previously noted, other sensors (e.g. infrared, ultrasound) may be used in alternate or additional embodiments. If a weight is detected on a seat 110, reporting occupancy, at block 440, includes identifying the particular seat 110 as well as indicating that it is occupied. This reporting, at block 440, is further discussed.

According to alternate or additional embodiments, a check may be done, at block 430, of seatbelts 175 that are engaged within some specified time of one or more doors 185 transitioning from the open to the closed position. The seatbelt sensor 170 associated with each seatbelt 175 may determine if the seatbelt 175 has been buckled and report that information to the controller 140. The seatbelt 175 may be buckled before or after the door 185 has been closed. That is, the controller 140 may receive the seatbelt sensor 170 signal or the door sensor 180 signal first and must make the determination, at block 430, of whether the other sensor signal has been received within a specified time. For example, if the seatbelt sensor 170 associated with the front passenger seat 110b sends a signal to the controller 140 to indicate that the seatbelt 175 has been buckled, the controller 140 determines, at block 430, whether the door sensor 180 associated with the passenger door 185 provides a signal that the door 185 has closed within five minutes of the seatbelt 175 being buckled.

When a seatbelt 175 has been buckled within a specified time of a door 185 closing, the processes include reporting occupancy, at block 440. As previously noted, reporting the occupancy, at block 440, includes indicating the presence of one or more passengers and, additionally, the seats 110 occupied by those passengers. The occupancy may be determined based on weight, at block 420, and/or based on the seatbelt sensor 170, at block 430. As FIG. 4 indicates, at block 445, no action is taken (i.e., reporting occupancy is not performed at block 440) if the checks at both blocks 420 and 430 indicate that no passenger is present. The occupancy information reported at block 440 is used in the processing at block 250 according to an exemplary embodiment. In this case, it is determined if the passenger position matches a determined location of a cellular device 120. The occupancy information reported at block 440 is used in the processing at blocks 320 and 350 according to another exemplary embodiment. At block 320, the door 185 associated with entry of each key fob 190 is of interest.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. A method of controlling a cellular device in a vehicle, the method comprising:
whether a location of the cellular device is in an area defined as a driver zone using an ultra-wideband system to determine the location of the cellular device within the vehicle based on a time of flight of an ultra-wideband signal to the cellular device and back to the ultra-wideband system; and
automatically inhibiting functionality of the cellular device using the processor based on determining that the cellular device is in the area defined as the driver zone using the ultra-wideband system, wherein the inhibiting functionality includes disabling one or more functions of the cellular device.

2. (canceled)

3. The method according to claim 1, wherein the determining the location of the cellular device includes determining whether the location of the cellular device is closer to a driver seat in the vehicle than to any other seat in the vehicle.

4. The method according to claim 1, further comprising determining whether a passenger is present in a seat closest to the location of the cellular device based on determining that the cellular device is not in the area defined as the driver zone in the vehicle.

5. The method according to claim 4, further comprising performing the inhibiting functionality of the cellular device automatically based on the determining whether the passenger is present indicating that the passenger is not present in the seat closest to the location of the cellular device.

6-8. (canceled)

9. The method according to claim 1, wherein the inhibiting functionality of the one or more functions includes inhibiting texting, internet searching, and gaming functionality.

10. The method according to claim 1, wherein the inhibiting functionality also includes maintaining mapping functionality and Bluetooth connectivity to an infotainment system of the vehicle.

11. A system to control a cellular device in a vehicle, the system comprising:
a processor configured to determine whether a location of the cellular device is in an area defined as a driver zone or using an ultra-wideband system to determine the location of the cellular device within the vehicle based on a time of flight of an ultra-wideband signal to the cellular device and back to the ultra-wideband system; and
a communication unit configured to automatically inhibit functionality of the cellular device based on determining that the cellular device is in the area defined as the driver zone using the ultra-wideband system, wherein the inhibiting functionality includes disabling one or more functions of the cellular device.

12. (canceled)

13. The system according to claim 11, wherein the processor is further configured to determine the location of the cellular device by determining whether the location of the cellular device is closer to a driver seat in the vehicle than to any other seat in the vehicle.

14. The system according to claim 11, wherein the processor is further configured to determine whether a passenger is present in a seat closest to the location of the cellular device when the processor determines that the cellular device is not in the area defined as the driver zone in the vehicle.

15. The system according to claim 14, wherein the communication unit is further configured to signal the cellular device to automatically inhibit functionality based on the processor determining that the passenger is not present in the seat closest to the location of the cellular device.

16-18. (canceled)

19. The system according to claim 11, wherein the one or more functions include texting, internet searching, and gaming functionality.

20. The system according to claim 11, wherein the processor inhibiting functionality also includes maintaining mapping functionality and Bluetooth connectivity to an infotainment system of the vehicle.
